(19) United States
(12) Patent Application Publication
(10) Pub. No.: US 2026/0122531 A1
(43) Pub. Date: Apr. 30, 2026

(54) SYSTEMS, METHODS, AND DEVICES FOR BUFFER STATUS REPORT (BSR) REPORTING

(71) Applicant: Apple Inc., Cupertino, CA (US)

(72) Inventors: Neha GOEL, Oceanside, CA (US); Vijay VENKATARAMAN, San Jose, CA (US); Sreevalsan VALLATH, Dublin, CA (US); Divyaprakash P. BHOJKUMAR, San Jose, CA (US)

(21) Appl. No.: 19/369,004

(22) Filed: Oct. 24, 2025

Related U.S. Application Data
(60) Provisional application No. 63/712,221, filed on Oct. 25, 2024.

(51) Int. Cl. H04W 28/02; H04L 5/00

(52) U.S. Cl. CPC H04W 28/0278; H04L 5/0044

(57) ABSTRACT

Described herein are techniques for buffer status report (BSR) reporting. These techniques can include reporting a next higher BSR index for shallow baseband queues; estimating packet arrival times based on BSR reporting; providing a delay status report (DSR) for data in baseband queues; indicating whether logical channels (LCHs) correspond to shallow baseband queues; indicating buffer occupancy for shallow baseband queues; arbitrating between time domain resource allocations based on baseband buffer capabilities; and BSR retransmission timers and SR delay timers. These and many other features and examples are described herein.

### CROSS REFERENCE TO RELATED APPLICATIONS

This application claims the benefit of U.S. Provisional Application No. 63/712,221, filed Oct. 25, 2024, the content of which is herein incorporated by reference in its entirety for all purposes.

### FIELD

This disclosure relates to wireless communication networks and mobile device capabilities.

### BACKGROUND

Wireless communication networks and wireless communication services are becoming increasingly dynamic, complex, and ubiquitous. For example, some wireless communication networks can be developed to implement fifth generation (5G) or new radio (NR) technology, sixth generation (6G) technology, and so on. Such technology can include solutions for enabling user equipment (UE) and network devices, such as base stations, to communicate with one another.

### BRIEF DESCRIPTION OF THE DRAWINGS

The present disclosure will be readily understood and enabled by the detailed description and accompanying figures of the drawings. Like reference numerals can designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and can mean at least one, one or more, etc.

FIG. 1 is a diagram of an example environment according to one or more implementations described herein.

FIG. 2 is a diagram of an example of a process for buffer status report (BSR) reporting according to one or more implementations described herein.

FIG. 3 is a diagram of an example table of buffer size levels according to one or more implementations described herein.

FIG. 4 is a diagram of an example of providing a delay status report (DSR) according to one or more implementations described herein.

FIG. 5 is a diagram of an example of a DSR media access control (MAC) control element (CE) according to one or more implementations described herein.

FIG. 6 is a diagram of an example of a DSR MAC CE and example table for reporting buffered data of a logical channel (LCH) and/or LCH group (LCG) according to one or more implementations described herein.

FIG. 7 is a diagram of an example of a process for indicating buffer occupancy according to one or more implementations described herein.

FIG. 8 is a diagram of an example of indicating buffer occupancy according to one or more implementations described herein.

FIG. 9 is a diagram of an example of arbitrating between parameters based on baseband buffer capability according to one or more implementations described herein.

FIG. 10 is a diagram of an example of a process for arbitrating between parameters based on baseband buffer capability according to one or more implementations described herein.

FIG. 11 is a diagram of an example of a process for retransmitting a BSR and scheduling request (SR) according to one or more implementations described herein.

FIG. 12 is a diagram of an example of components of a device according to one or more implementations described herein.

FIG. 13 is a diagram of example interfaces of baseband circuitry according to one or more implementations described herein.

FIG. 14 is a block diagram illustrating components, according to one or more implementations described herein, able to read instructions from a machine-readable or computer-readable medium (e.g., a non-transitory machine-readable storage medium) and perform any one or more of the methodologies discussed herein.

FIG. 15 is a block diagram of an example logic flow according to one or more implementations described herein.

### DETAILED DESCRIPTION

The following detailed description refers to the accompanying drawings. Like reference numbers in different drawings can identify the same or similar features, elements, operations, etc. Additionally, the present disclosure is not limited to the following description as other implementations can be utilized, and structural or logical changes made, without departing from the scope of the present disclosure.

The following detailed description includes a variety of terms and phrases, which can be expressed as an acronym. Non-limiting examples of these terms and phrases are provided below.
Buffer status report (BSR)
Buffer size (BS)
Delay status report (DSR)
Scheduling request (SR)
User equipment (UE)
Baseband (BB) circuitry
Radio access network (RAN)
Core network (CN)
Radio link control (RLC)
Media access control (MAC)
Packet data convergence protocol (PDCP)
Service data unit (SDU)
Protocol data unit (PDU)
Explicit congestion notification (ECN)
Telecommunications and digital government regulatory authority (TDRA)
Transmission (Tx)
Reception (Rx)
Acknowledgement (ACK)
Negative acknowledgement (NACK)
Logical channel (LCH)
Logical channel group (LCG)
Application (AP)
Best effort (BE)
Low latency (LL)
Active queue management (AQM)
Physical uplink shared channel (PUSCH)
Physical downlink control channel (PDCCH)
Quality of service (QoS)

Wireless communication networks can include UE capable of communicating with base stations and/or other network devices. The base stations can provide a UE with access to a CN. The CN can authenticate UE, register the UE with the network, provide user plane and control plane connectivity, and more. An aspect of wireless communication networks can include scheduling and allocated time and frequency resource to enable wireless communications between the UE and the base station.

A UE can include baseband circuitry configured to implement a buffering system or queue for transmitting data to a base station or another type of radio access network (RAN). The size of a baseband queue can vary depending on one or more factors, such as the baseband circuitry, a configuration of the baseband circuitry, an LCH or LCG associated with the queue, and so on. A non-shallow (or normal) baseband queue, as referred to herein, can include a greater number of transmission time intervals (TTIs) worth of data than that of a shallow baseband queue. A non-shallow (or normal) baseband queue can correspond to a higher or highest BSR index as specified by 3GPP technical specification (TS) 38.331. By contrast, a shallow baseband queue, as referred to herein, can include a relatively few TTIs worth of data compared to queues supporting a highest BSR index. A low or shallow baseband queue can be implemented to help reduce buffering at the baseband circuitry of a UE and to increase responsiveness of the UE. A shallow baseband queue, as referred to herein, can also be referred to as a shallow baseband buffer, shallow buffer, etc.

A shallow baseband buffer can affect scheduling, bandwidth allocation, and latency as the UE can be configured to send a SR to transmit a BSR based on the size or status of the baseband buffer or the baseband queue, and the RAN can allocate resources to the UE based on the BSR. Currently available techniques for implementing shallow baseband queues can include one or more of the following deficiencies.
Waste or inefficient use of resources (e.g., when a grant is bigger than a BB queue size) can result in resource penalties imposed by the network in the form of less frequent and/or smaller grants.
Baseband circuitry that is always over reporting (e.g., when an AP is updating the queue size to baseband circuitry every 10 milliseconds (ms).
Successive BSRs with a high index can lead to congestion experienced ECN marking being triggered at the base station, and rate adaptation can be triggered due to over-reporting.
A BSR being sent in every grant, resulting in additional processing at the base station and high channel overload.
Padding/frequent BSRs can be ignored in some network infrastructure implementations since TDRA for high priority/new data has been allocated.
Interference with SR/BSR optimizations supported by some network infrastructure implementations.

Implementing BSR reporting can include a scheduling request, resource grant, BSR transmission, and one or more additional resources grants and BSR transmissions. This can involve and/or be based on one or more resource allocation parameters, such as a k0, k1, k2, N1, N2, and one or more other types of parameters. A k2 can include a parameter related to resource allocation in a time domain for acknowledgement and/or negative acknowledgement (ACK/NACK) responses. A k2 can indicate a number of time slots between a physical downlink control channel (PDCCH) and/or downlink control information (DCI) and uplink data of a physical uplink shared channel (PUSCH) transmission. BSR reporting and implementing a k2 can include a data volume calculation. The calculation can relate to RLC data and PDCP data. The calculation can include, or be based on, one or more of: RLC SDUs and segments not included as RLC PDUs; RLC PDUs for Tx; and/or RLC PDUs for retransmission (Re-Tx). The calculation can also, or alternatively, be based on one or more of: PDCP SDUs (not constructed PDCP PDUs); PDCP PDUs not sent to RLC; and PDCP Control PDUs.

One or more of the techniques described herein include solutions for optimizing BSR reporting. In some implementations, optimized BSR reporting can involve obtaining fragmented grants from a RAN to flush out baseband queues without having to transmit a SR; leveraging BSR in a manner that does not waste resources that might otherwise be involved in requesting fragmented grants from the RAN; and/or signaling to inform the RAN about the use of shallow baseband queues in order to obtain different scheduling treatment and avoiding scheduling delays. One or more of these techniques can be directed to scenarios involving low or shallow baseband queues, which can reduce buffering at the baseband circuitry and increase responsiveness. This can improve scenarios in which BSR reporting might otherwise involve repeated scheduling requests, cumbersome time and frequency resource scheduling, latency issues, and so on. Different aspects and examples of these techniques are described below with reference to the figures.

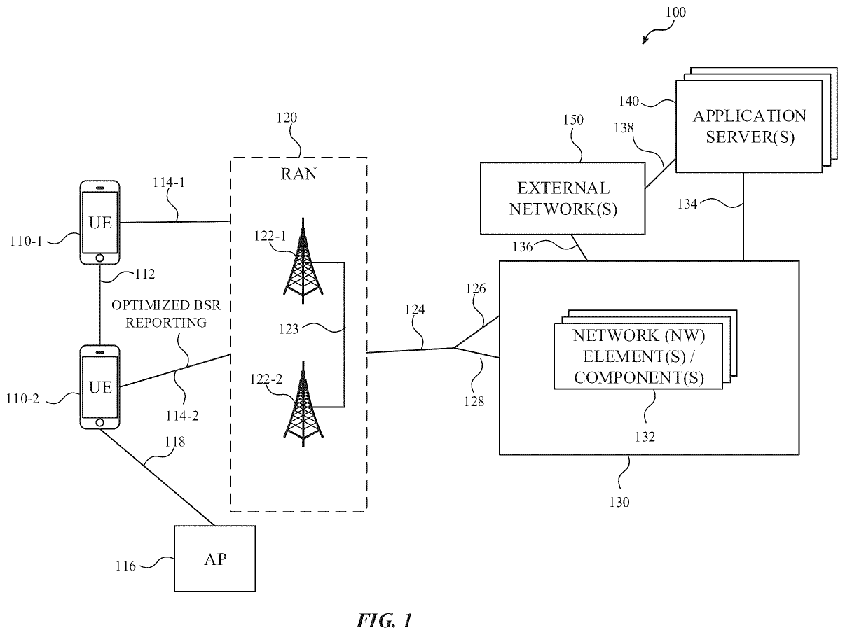

FIG. 1 is an example environment 100 in which one or more of the techniques described herein can be implemented. Example environment 100 can include UEs 110-1, 110-2, etc. (referred to collectively as “UEs 110” and individually as “UE 110”), a radio access network (RAN) 120, a core network (CN) 130, application servers 140, external networks 150.

The systems and devices of example environment 100 can operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example environment 100 can operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards, and more.

As shown, UEs 110 can include smartphones (e.g., handheld touchscreen mobile computing devices connectable to one or more wireless communication networks). Additionally, or alternatively, UEs 110 can include other types of mobile or non-mobile computing devices capable of wireless communications, such as personal data assistants (PDAs), pagers, laptop computers, desktop computers, wireless handsets, etc. In some implementations, UEs 110 can include Internet of Things (IoT) devices (or IoT UEs) that can implement narrowband (NB) communications and that can comprise, for example, a network access layer designed for low-power IoT applications utilizing short-lived UE connections. Additionally, or alternatively, an IoT UE can utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data can be a machine-initiated exchange, and an IoT network can include interconnecting IoT UEs (which can include uniquely identifiable embedded computing devices within an Internet infrastructure) with short-lived connections. In some scenarios, IoT UEs can execute background applications (e.g., keep-alive messages, status updates, etc.) to facilitate the connections of the IoT network.

UEs 110 can communicate and establish a connection with one or more other UEs 110 via one or more wireless channels 112, each of which can comprise a physical communications interface/layer. The connection can include an M2M connection, MTC connection, D2D connection, SL connection, etc. The connection can involve a PC5 interface. In some implementations, UEs 110 can be configured to discover one another, negotiate wireless resources between one another, and establish connections between one another, without intervention or communications involving RAN node 122 or another type of network node. In some implementations, discovery, authentication, resource negotiation, registration, etc., can involve communications with RAN node 122 or another type of network node.

UEs 110 can communicate and establish a connection with RAN 120, which can involve one or more wireless channels 114-1 and 114-2, each of which can comprise a physical communications interface/layer. In some implementations, a UE can be configured with dual connectivity (DC) as a multi-radio access technology (multi-RAT) or multi-radio dual connectivity (MR-DC), where a multiple receive and transmit (Rx/Tx) capable UE can use resources provided by different network nodes (e.g., 122-1 and 122-2) that can be connected via non-ideal backhaul (e.g., where one network node provides NR access and the other network node provides either E-UTRA for LTE or NR access for 5G). A network node can be referred to herein as a base station 122. In such a scenario, one network node can operate as a master node (MN) and the other as the secondary node (SN). The MN and SN can be connected via a network interface, and at least the MN can be connected to the CN 130. In some implementations, a base station (as described herein) can be an example of network node 122. In some scenarios, RAN 120 can coordinate with core network 130 via interfaces 124, 126, and/or 128.

As shown, UE 110 can also, or alternatively, connect to access point (AP) 116 via connection interface 118, which can include an air interface enabling UE 110 to communicatively couple with AP 116. AP 116 can comprise a wireless local area network (WLAN), WLAN node, WLAN termination point, etc. The connection 116 can comprise a local wireless connection, such as a connection consistent with any IEEE 702.11 protocol, and AP 116 can comprise a wireless fidelity (Wi-Fi®) router or other access point device. While not explicitly depicted in FIG. 1, AP 116 can be connected to another network (e.g., the Internet) without connecting to RAN 120 or CN 130.

One or more of the techniques described herein include solutions for BSR reporting. These techniques can cause or enable UE 110 and/or RAN 120 to perform one or more processes or procedures, such as reporting a next higher BSR index for shallow baseband queues; estimating packet arrival times based on BSR reporting; providing a delay status report (DSR) for data in baseband queues; indicating whether logical channels (LCHs) correspond to shallow baseband queues; indicating buffer occupancy for shallow baseband queues; arbitrating between time domain resource allocations based on baseband buffer capabilities; and BSR retransmission timers and SR delay timers. These and many other features and examples are described herein.

RAN 120 can include one or more RAN nodes 122-1 and 122-2 (referred to collectively as RAN nodes 122, and individually as RAN node 122) that enable channels 114-1 and 114-2 to be established between UEs 110 and RAN 120. RAN nodes 122 can include network access points configured to provide radio baseband functions for data and/or voice connectivity between users and the network based on one or more of the communication technologies described herein (e.g., 1G, 3G, 4G, 5G, WiFi, etc.). As examples therefore, a RAN node can be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 122 can include a roadside unit (RSU), a transmission reception point (TRxP or TRP), and one or more other types of ground stations (e.g., terrestrial access points). In some scenarios, RAN node 122 can be a dedicated physical device, such as a macrocell base station, and/or a low power (LP) base station for providing femtocells, picocells or the like having smaller coverage areas, smaller user capacity, or higher bandwidth compared to macrocells. A RAN node can generally be referred to herein as base station 122.

Some or all of RAN nodes 122, or portions thereof, can be implemented as one or more software entities running on server computers as part of a virtual network, which can be referred to as a centralized RAN (CRAN) and/or a virtual baseband unit pool (vBBUP). In these implementations, the CRAN or vBBUP can implement a RAN function split, such as a packet data convergence protocol (PDCP) split wherein radio resource control (RRC) and PDCP layers can be operated by the CRAN/vBBUP and other Layer 1 (L2) protocol entities can be operated by individual RAN nodes 122; a media access control (MAC)/physical (PHY) layer split wherein RRC, PDCP, radio link control (RLC), and MAC layers can be operated by the CRAN/vBBUP and the PHY layer can be operated by individual RAN nodes 122; or a “lower PHY” split wherein RRC, PDCP, RLC, MAC layers and upper portions of the PHY layer can be operated by the CRAN/vBBUP and lower portions of the PHY layer can be operated by individual RAN nodes 122. This virtualized framework can allow freed-up processor cores of RAN nodes 122 to perform or execute other virtualized applications.

In some implementations, an individual RAN node 122 can represent individual gNB-distributed units (DUs) connected to a gNB-control unit (CU) via individual F1 or other interfaces. In such implementations, the gNB-DUs can include one or more remote radio heads or radio frequency (RF) front end modules (RFEMs), and the gNB-CU can be operated by a server (not shown) located in RAN 120 or by a server pool (e.g., a group of servers configured to share resources) in a similar manner as the CRAN/vBBUP. Additionally, or alternatively, one or more of RAN nodes 122 can be next generation eNBs (i.e., gNBs) that can provide evolved universal terrestrial radio access (E-UTRA) user plane and control plane protocol terminations toward UEs 110, and that can be connected to a 5G core network (5GC) 130 via an NG interface.

Any of the RAN nodes 122 can terminate an air interface protocol and can be the first point of contact for UEs 110. In some implementations, any of the RAN nodes 122 can fulfill various logical functions for the RAN 120 including, but not limited to, radio network controller (RNC) functions such as radio bearer management, uplink and downlink dynamic radio resource management and data packet scheduling, and mobility management. UEs 110 can be configured to communicate using orthogonal frequency-division multiplexing (OFDM) communication signals with each other or with any of the RAN nodes 122 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals can comprise a plurality of orthogonal subcarriers.

In some implementations, a downlink resource grid can be used for downlink transmissions from any of the RAN nodes 122 to UEs 110, and uplink transmissions can utilize similar techniques. The grid can be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements (REs). Each resource block can comprise a collection of resource elements; in the frequency domain, this can represent the smallest quantity of resources that currently can be allocated. There are several different physical downlink channels that are conveyed using such resource blocks.

Further, RAN nodes 122 can be configured to wirelessly communicate with UEs 110, and/or one another, over a licensed medium (also referred to as the “licensed spectrum” and/or the “licensed band”), an unlicensed shared medium (also referred to as the “unlicensed spectrum” and/or the “unlicensed band”), or combination thereof. A licensed spectrum can correspond to channels or frequency bands selected, reserved, regulated, etc., for certain types of wireless activity (e.g., wireless telecommunication network activity), whereas an unlicensed spectrum can correspond to one or more frequency bands that are not restricted for certain types of wireless activity.

The PDSCH can carry user data and higher layer signaling to UEs 110. The physical downlink control channel (PDCCH) can carry information about the transport format and resource allocations related to the PDSCH channel, among other things. The PDCCH can also inform UEs 110 about the transport format, resource allocation, and hybrid automatic repeat request (HARQ) information related to the uplink shared channel. Typically, downlink scheduling (e.g., assigning control and shared channel resource blocks to UE 110 within a cell) can be performed at any of the RAN nodes 122 based on channel quality information feedback from any of UEs 110. The downlink resource assignment information can be sent on the PDCCH used for (e.g., assigned to) each of UEs 110.

One or more of the techniques described herein can allow UE 110 to monitor UL traffic of an application or wireless link, detect an increase in UL traffic, and communicate with the network (e.g., base station 122, etc.,) to dynamically increase UL resources. The increase in UL resource can include a change in the number of UL slots per frame. In doing so, UE 110 can determine the UL requirements of the application, assess a current usage of UL resources, and more. For example, UE 110 can verify that DL resources are underused, before requesting an increase in UL resource. UL performance can thus be increased without a meaningful decrease in DL performance, as the increase in UL resources can be achieved by a decrease DL resources. Dynamically increasing the UL resources can enable the UE to improve UL performance commensurate with the requirements or preferences of applications that generate significant UL traffic, engage in edge compute offloading (e.g., application servers 140), and more. Many other aspects and examples are also described herein.

The RAN nodes 122 can be configured to communicate with one another via interface 123. In implementations where the system is an LTE system, interface 123 can be an X2 interface. In NR systems, interface 123 can be an Xn interface. The X2 interface can be defined between two or more RAN nodes 122 (e.g., two or more eNBs/gNBs or a combination thereof) that connect to evolved packet core (EPC) or CN 130, or between two eNBs connecting to an EPC.

As shown, RAN 120 can be connected (e.g., communicatively coupled) to CN 130. CN 130 can comprise a plurality of network elements 132, which are configured to offer various data and telecommunications services to customers/subscribers (e.g., users of UEs 110) who are connected to the CN 130 via the RAN 120. In some implementations, CN 130 can include an evolved packet core (EPC), a 5G CN (5GC), and/or one or more additional or alternative types of CNs.

As shown, CN 130, application servers 140, and external networks 150 can be connected to one another via interfaces 134, 136, and 138, which can include IP network interfaces. Application servers 140 can include one or more server devices or network elements (e.g., virtual network functions (VNFs) offering applications that use IP bearer resources with CN 130 (e.g., universal mobile telecommunications system packet services (UMTS PS) domain, LTE PS data services, etc.). Application servers 140 can also, or alternatively, be configured to support one or more communication services (e.g., voice over IP (VOIP sessions, push-to-talk (PTT) sessions, group communication sessions, social networking services, etc.) for UEs 110 via the CN 130. Similarly, external networks 150 can include one or more of a variety of networks, including the Internet, thereby providing the mobile communication network and UEs 110 of the network access to a variety of additional services, information, interconnectivity, and other network features.

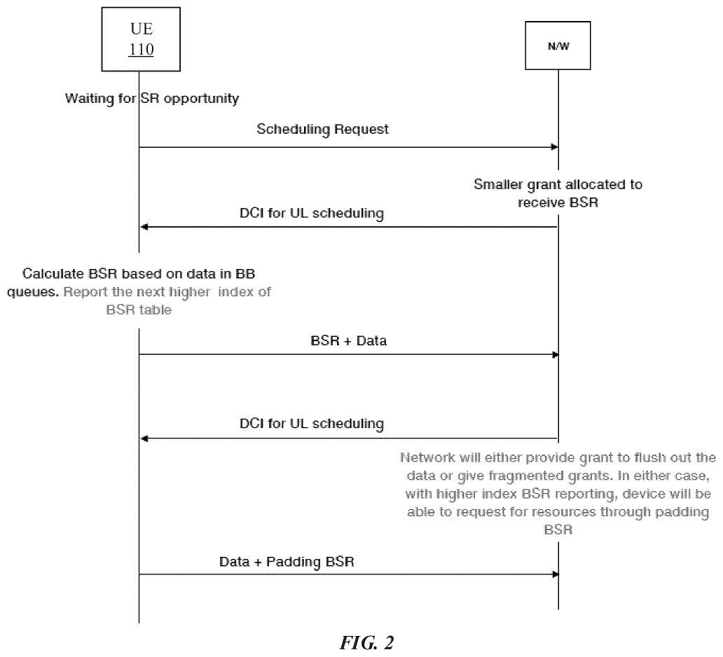

FIG. 2 is a diagram of an example of a process 200 for optimized buffer status report (BSR) reporting according to one or more implementations described herein. Process 200 can be an example of reporting a next higher BSR index with shallow queues. As shown, process 200 be performed by UE 110 and RAN 120. Operations described as being performed by UE 110 can be performed, at least in part, by baseband circuitry of UE 110. RAN 120 can be implemented by base station 122 or another type of network access point. Some or all of process 200 can be performed by one or more other systems or devices, including one or more of the devices of FIG. 1. Additionally, process 200 can include one or more fewer, additional, differently ordered, and/or arranged operations than those shown in FIG. 2. Some or all of the operations of process 200 can be performed independently, successively, simultaneously, etc., of one or more of the other operations of process 200. As such, the techniques described herein are not limited to the number, sequence, arrangement, timing, etc., of the operations or processes depicted in FIG. 2.

As shown, UE 110 can wait for an SR opportunity and communicate a SR to RAN 120 during the SR opportunity. RAN 120 can determine a smaller grant to be allocated to receive a BSR of from UE 110 and can communicate DCI for UL scheduling. UE 110 can determine or calculate a BSR based on data in one or more baseband queues. UE 110 can also determine a next higher index of a BSR table. UE 110 can include the next higher index in the BSR. In some implementations, UE 110 can indicate the next higher index via another type of data structure, report, and/or transmission.

UE 110 communicate the BSR and data from the baseband queues to RAN 120, and RAN 120 can respond by providing UE 110 with DCI for UL scheduling. RAN 120 can provide (e.g., via the DCI) a grant to flush out the data of the baseband queues or provide UE 110 with fragmented grants to flush out the data of the baseband queues. The higher index BSR reporting can result in UE 110 being able to request resources through padding BSR. As such, UE 110 can communicate data and padding BSR to RAN 120.

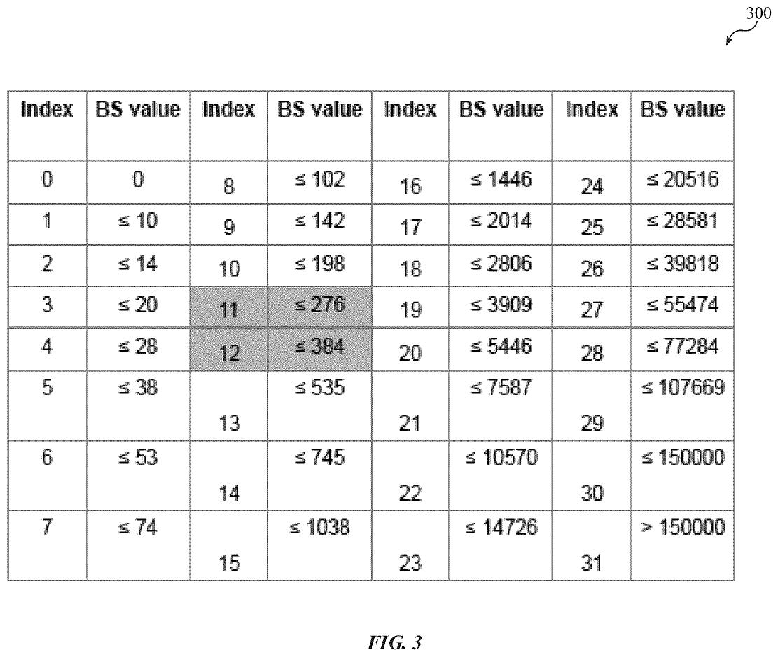

FIG. 3 is a diagram of an example table 300 of buffer size levels according to one or more implementations described herein. As shown, example table 300 can include index values associated with buffer size (BS) values. The buffer size values can be indicated in bytes (e.g., of a 5-bit buffer size field). UE 110 can use example table 300 to determine and report a next higher BSR index with shallow queues. This can enable UE 110 to frequently report BSRs (padding BSRs) in a manner that does not waste time and/or frequency resources while also maximizing overall data transmissions. UE 110 can determine or calculate a volume of data present in one or more baseband queues. The volume of data can be a buffer size. UE 110 can use example table 300 to determine a BSR index associated with the buffer size and further use example table 300 to determine a BSR index that is one greater (e.g., the next higher BSR index) than the BSR index associated with the buffer size. Referring to example table 300, if the a BSR index associated with the buffer size is 11, for example, the next higher BSR index can be 12.

UE 110 can provide the next higher BSR index to RAN 120. RAN 120 can respond by determining a grant large enough to flush out the data queued in baseband buffer. RAN 120 can provide UE 110 with the grant. The grant can enable or allow UE 110 to engage in BSR padding, which can help ensure that resources are not wasted and RAN 120 does not penalize UE 110. UE 110 can determine BSR padding based on a buffer size. The buffer size can be an amount of data in the baseband queues or a size of the baseband buffer. UE 110 can determine BSR padding, report a padded BSR, and report a buffer size value based on the following.
When baseband data <=0; Report BSR index sent in previous BSR if data is present in AP, TR, AQM, drivers.
Baseband data >0; Calculate buffer size value based on remaining data in baseband queue and report next higher BSR index.

AP can include an application. TR can refer to one or more queues, ring buffers, or another type of a storage feature, data structure, or entity. A driver can refer to one or more a baseband device drivers. Packet arrival can be estimated based on BSR reports. With shallow baseband buffers, UE 110 can trigger a regular BSR as soon as the data is flushed out and new data has been fetched from AP/upper stack. A packet arrival and volume can be estimated based on periodic and regular BSR reception. A TDRA can cause devices to be configured to reflect or indicate the estimated packet arrival and volume in a PUSCH-TimeDomainAllocationList lookup table in PUSCH-Config. In some implementations, another type of message, data structure, parameter, or value can be used. The PUSCH-TimeDomainAllocationList lookup table in PUSCH-Config can be based on a historical analysis of regular BSRs and/or periodic BSRs. A regular BSR can involve high priority data, new data in a baseband queue, and/or a retransmission BSR timer duration or expiration. Periodic BSRs can include BSR transmitted according to a schedule and/or one or more parameters, constraints, triggers, or conditions.

A volume of data and arrival time between BSR transmissions can be estimated. Data arrival estimation can be based on the following.
Time interval (subframe in ms) between reception of two successive BSRs (a)=BSR (t+1)−BSR (t), where t is time.
Volume of data reported in BSR (t)=r (t)
Volume of data reported in BSR (t+1)=r (t+1)
Data arrival (dₜ₊₁)=[r(t+1)−r(t)]/a

A TDRA can cause devices to be configured to reflect the data arrival in the resource assignment, the estimated packet arrival, and volume in BSR (t+1) in PUSCH-TimeDomainAllocationList lookup table in PUSCH-Config.

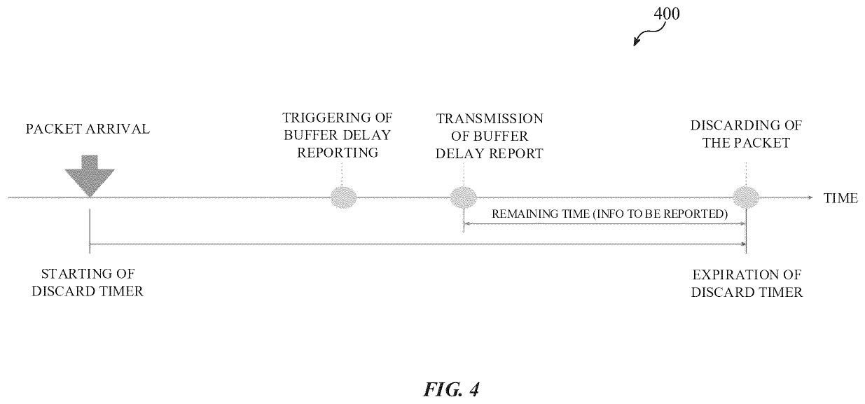

FIG. 4 is a diagram of an example 400 of providing a delay status report (DSR) according to one or more implementations described herein. UE 110 can determine and provide a DSR for data queued by baseband circuitry. The DSR can be configured to inform RAN 120 of the buffered data in the baseband circuitry via a dedicated MAC CE. The DSR can indicate the amount of data buffered with a remaining time before a discard operation below the configured threshold, together with the shortest remaining time of any PDCP SDU buffered. The purpose of the DSR is to inform RAN 120 how much data has to be transmitted within a time period. Proposal is to utilize DSR and buffer status for getting frequent grants from RAN 120.

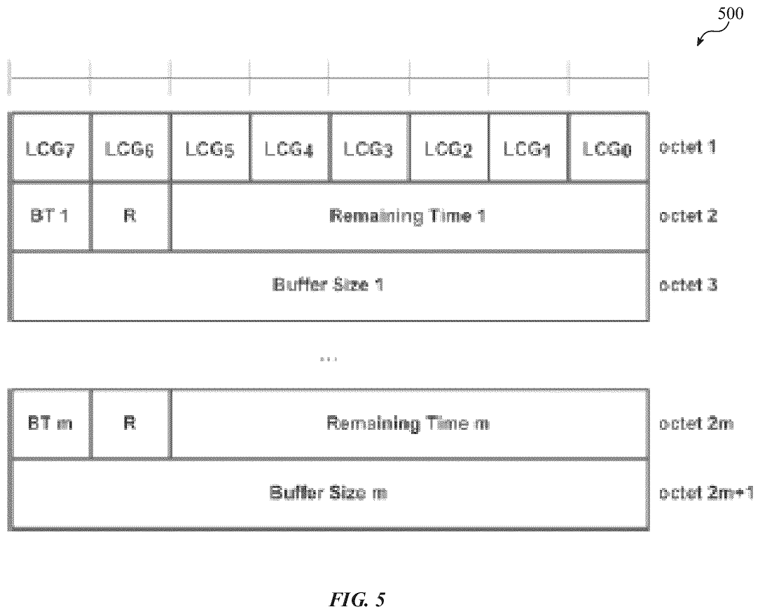

FIG. 5 is a diagram of an example 500 of a DSR media access control (MAC) control element (CE) according to one or more implementations described herein. UE 110 can determine and provide a DSR for data queued by baseband circuitry. The DSR can be configured to inform RAN 120 of the buffered data in the baseband circuitry via a dedicated MAC CE. Fields in the DSR MAC CE can be defined as follows.

The LCGᵢ field can indicate the presence of delay information (i.e. the Remaining Time and Buffer Size fields) for the LCGᵢ. The LCGᵢ field set to 1 can indicate that the delay information for the LCGᵢ is reported. The LCGᵢ field set to 0 can indicate that the delay information for the LCGᵢ is not reported. The Remaining Time field can indicate the shortest remaining value of a running PDCP discardTimer among all PDCP SDUs that are buffered for an LCG but have not been transmitted in any MAC PDU, at the time of the first symbol of the first PUSCH transmission that includes this DSR MAC CE. The BT field can be present when (e.g., only if) a corresponding LCG is configured with additionalBS-TableAllowed and the buffer size indicated by the corresponding Buffer Size field is not zero; otherwise, this field can be reserved and set to 0. The DSR MAC CE can include delay information of all LCGs that have pending DSRs when the MAC PDU containing this DSR MAC CE is to be built.

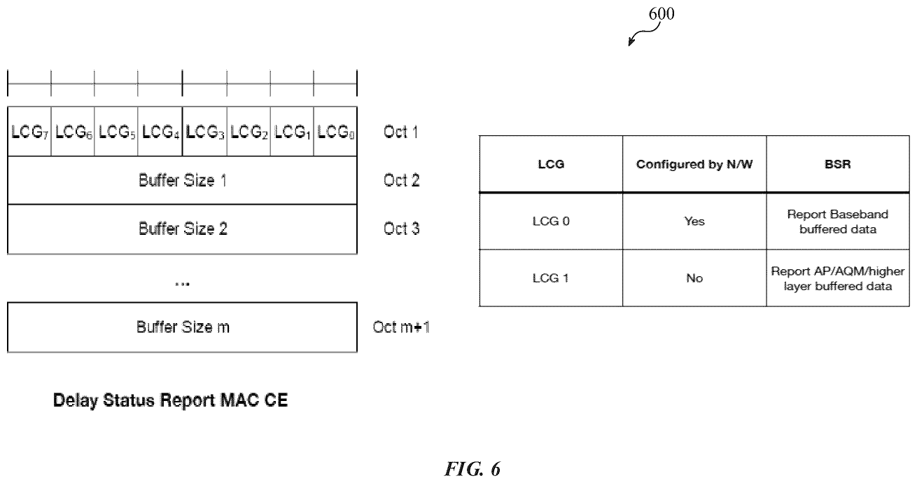

FIG. 6 is a diagram of an example 600 of a DSR MAC CE and example table for reporting buffered data of a logical channel (LCH) and/or LCH group (LCG) according to one or more implementations described herein. UE 110 inform RAN 120 about whether UE 110 supports shallow queues. UE 110 can do so by reporting AP data on an LCH/LCG that has not been configured by RAN 120. Example 600 includes an example of a DSR MAC CE that UE 110 can use to inform RAN 120. The DSR MAC CE can include a signature to indicate that the baseband queues are small and are configured for frequent grants from RAN 120. Example 600 also includes a table indicating different LCGs (e.g., LCG₀ and LCG₁), whether each LCG has been configured by the network (e.g., RAN 120), and reporting configuration for each LCG.

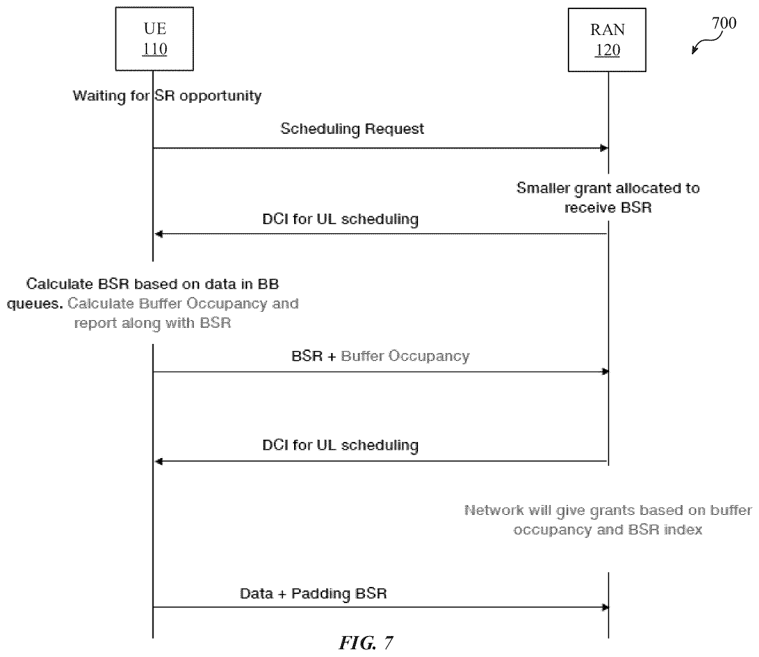

FIG. 7 is a diagram of an example of a process 700 for indicating buffer occupancy according to one or more implementations described herein. As shown, process 700 be performed by UE 110 and RAN 120. Operations performed by UE 110 can be performed, at least in part, by baseband circuitry of UE 110. RAN 120 can be implemented by base station 122 or another type of network access point. Some or all of process 700 can be performed by one or more other systems or devices, including one or more of the devices of FIG. 1. Additionally, process 700 can include one or more fewer, additional, differently ordered, and/or arranged operations than those shown in FIG. 7. Some or all of the operations of process 700 can be performed independently, successively, simultaneously, etc., of one or more of the other operations of process 700. As such, the techniques described herein are not limited to the number, sequence, arrangement, timing, etc., of the operations or processes depicted in FIG. 7.

As shown, UE 110 can wait for an SR opportunity and communicate a SR to RAN 120 during the SR opportunity. RAN 120 can determine a smaller grant to be allocated to receive a BSR of from UE 110 and can communicate DCI for UL scheduling. UE 110 can determine or calculate a BSR based on data in one or more baseband queues. The BSR can include a BSR index. UE 110 can also determine or calculate a buffer occupancy. UE 110 can include the buffer occupancy in the BSR. In some implementations, UE 110 can indicate the buffer occupancy via another type of data structure, report, and/or transmission.

UE 110 communicate the BSR and buffer occupancy to RAN 120, and RAN 120 can respond by providing UE 110 with DCI for UL scheduling. RAN 120 can determine one or more grants for UE 110 based on the buffer occupancy and a BSR index. RAN 120 can provide UE 110 with the grants (e.g., via the DCI). The one or more grants can be configured to flush out the data of the baseband queues or provide UE 110 with fragmented grants to flush out the data of the baseband queues. UE 110 can communicate data and padding BSR to RAN 120.

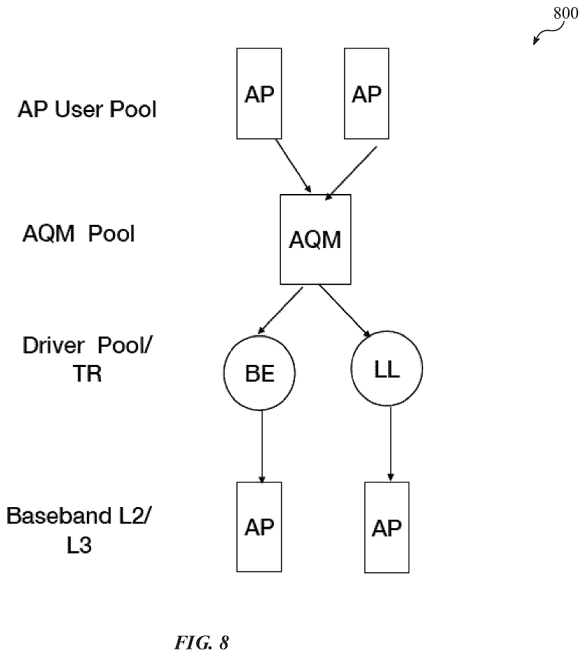

FIG. 8 is a diagram of an example 800 of indicating buffer occupancy according to one or more implementations described herein. There can be queueing at different architecture layers of UE 110, mainly application buffer, networking and drivers (e.g., AQM, TR, etc.). UE 110 can determine or calculate a buffer occupancy. UE 110 can communicate the buffer occupancy to RAN 120. The buffer occupancy can be based on, or associated with, one or more of the following.
Total buffer size across AP, AQM, drivers, TR, and baseband=Bₜ
Current buffer occupancy across all modules B_{C}(t)
Baseband Flush Rate R₁(t)=Queue size

A module can refer to instances of data queued or stored in baseband circuitry, a baseband memory, a memory of a baseband processor, etc., for one or more drivers or applications. AP can include an application. TR can refer to one or more queues, ring buffers, or another type of a storage feature, data structure, or entity. A driver can refer to one or more a baseband device drivers. C can refer to a current state or instance of time. A baseband flush rate can include a data rate with which the data of one or more queues can be flushed out. If there are no resources assigned to UE 110 in this regard, UE 110 may not be able to empty/flush its queues/buffers. UE 110 can indicate to RAN 120 whether UE 110 is capable of using shallow queues and buffer occupancy by accounting for data buffered in all the modules and the baseband flush rate.

UE 110 can determine and/or indicate the transmitted bytes associated with a buffer occupancy. The transmitted bytes can be based on, or associated with, one or more of the following.

$$\begin{matrix}□ & Input data rate {R}_{C} ( t ) = [ ( Number of Packets \times Packet size ) / Packet Interval ] + Buffering delay \\ □ & Buffer Occupancy {B}_{O} ( t + 1 ) = {B}_{C} ( t ) + ( {R}_{C} ( t ) - {R}_{1} ( t ) )\end{matrix}$$

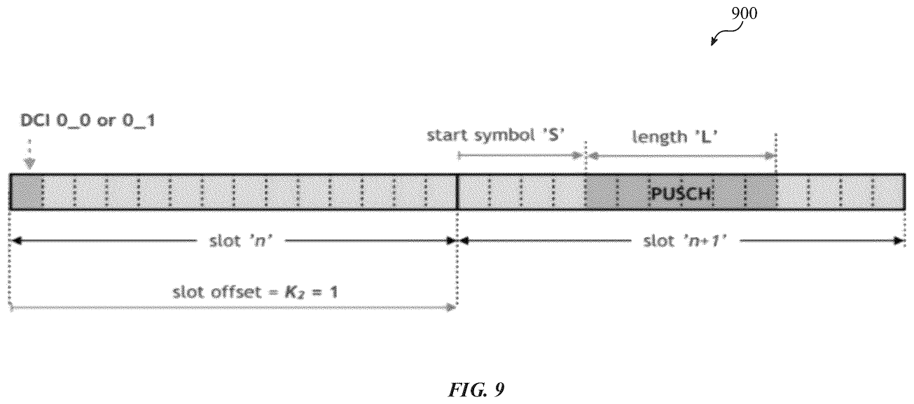

FIG. 9 is a diagram of an example 900 of arbitrating between parameters based on baseband buffer capability according to one or more implementations described herein. The parameters can be k2 values. BSR reporting can include a scheduling request, resource grant, BSR transmission, and one or more additional resources grants and BSR transmissions. This can involve and/or be based on one or more resource allocation parameters, such as a k0, k1, k2, N1, N2, and one or more other types of parameters.

One or more of the techniques described herein can include arbitrating between k2 values based on baseband buffer capability. The arbitrations can involve different k2 values for Use with different baseband buffer sizes. UEs 110 can have different baseband queue sizes. RAN 120 can achieve better latency by arbitrating different k2 values based on the baseband queue sizes of different UEs 110. With a bigger baseband queue size, better latency can be attained when a higher k2 value is provided to flush out the buffered data and the newly arrived data. Similarly for a shallow baseband queue size, better latency can be attained with shorter k2 thus providing more frequent grants to flush out the data to get replenished again. As shown in FIG. 9, arbitrating between parameters (e.g., k2 values) can involve a delay between UL grant reception in downlink (e.g., a PDCCH) and corresponding uplink data transmission (e.g., via a PUSCH).

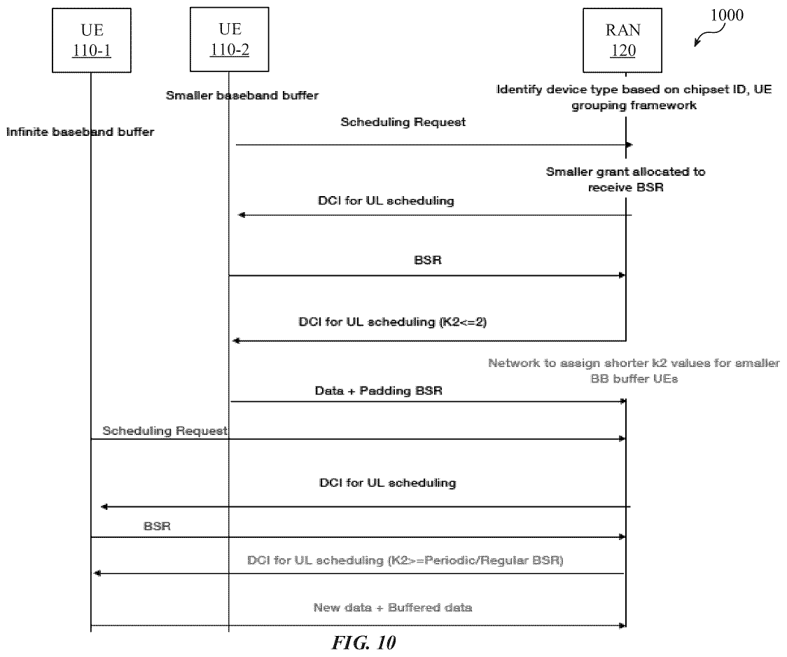

FIG. 10 is a diagram of an example of a process 1000 for arbitrating between parameters based on baseband buffer capability according to one or more implementations described herein. The parameters can be k2 values. BSR reporting can include a scheduling request, resource grant, BSR transmission, and one or more additional resources grants and BSR transmissions. This can involve and/or be based on one or more resource allocation parameters, such as a k0, k1, k2, N1, N2, and one or more other types of parameters.

As shown, process 1000 be performed by UE 110-1, UE 110-2, and RAN 120. Operations performed by UE 110-1 and/or UE 110-2 can be performed, at least in part, by baseband circuitry of UE 110-1 and/or UE 110-2. RAN 120 can be implemented by base station 122 or another type of network access point. Some or all of process 1000 can be performed by one or more other systems or devices, including one or more of the devices of FIG. 1. Additionally, process 1000 can include one or more fewer, additional, differently ordered, and/or arranged operations than those shown in FIG. 10. Some or all of the operations of process 1000 can be performed independently, successively, simultaneously, etc., of one or more of the other operations of process 1000. As such, the techniques described herein are not limited to the number, sequence, arrangement, timing, etc., of the operations or processes depicted in FIG. 10.

As shown, UE 110-1 and UE 110-2 can have baseband buffer sizes or capabilities. RAN 120 can identify a device type of UE 110-1 and UE 110-2 based on a chipset ID and/or UE grouping framework of UE 110-1 and UE 110-2. UEs 110-1 and 110-2 can communicate with RAN 120 to obtain uplink scheduling resources for BSR reporting. RAN 120 determine and assign different uplink scheduling resources (e.g., k2 values) to UE 110-1 and UE 110-2 based on the different baseband buffer sizes or capabilities of UE 110-1 and UE 110-2. UE 110-1 and UE 110-2 can provide RAN 120 with BSRs and data using different reporting schemes. UE 110-1 can use the uplink scheduling resources to provide data and padding BSR. UE 110-2 can use the uplink scheduling resources to provide new data and buffered data using periodic and/or regular BSR reporting. The uplink scheduling resources and the manner of communicating uplink data can be based on a k2 value assigned to UE 110-1 and UE 110-2.

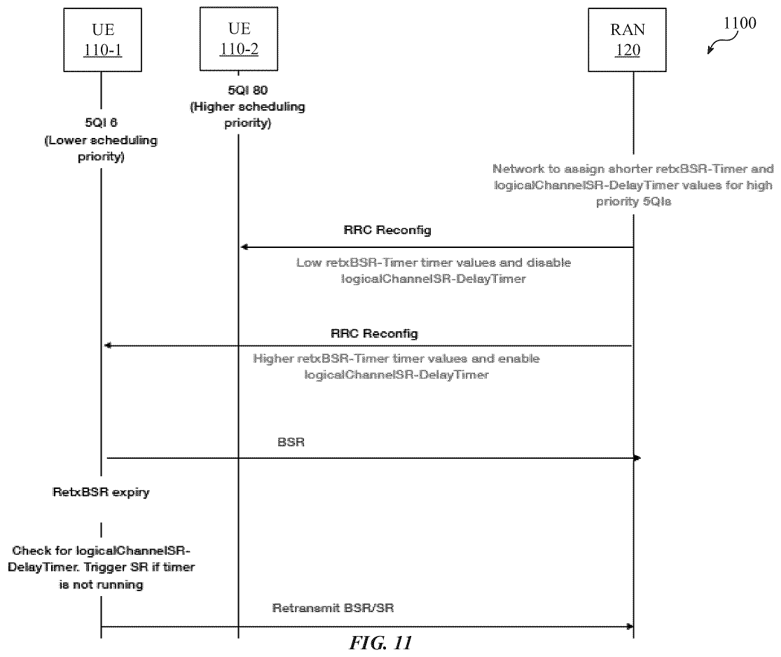

FIG. 11 is a diagram of an example of a process 1100 for retransmitting a BSR and/or SR according to one or more implementations described herein. As shown, process 1100 be performed by UE 110-1, UE 110-2, and RAN 120. Operations performed by UE 110-1 and/or UE 110-2 can be performed, at least in part, by baseband circuitry of UE 110-1 and/or UE 110-2. RAN 120 can be implemented by base station 122 or another type of network access point. Some or all of process 1100 can be performed by one or more other systems or devices, including one or more of the devices of FIG. 1. Additionally, process 1100 can include one or more fewer, additional, differently ordered, and/or arranged operations than those shown in FIG. 11. Some or all of the operations of process 1100 can be performed independently, successively, simultaneously, etc., of one or more of the other operations of process 1100. As such, the techniques described herein are not limited to the number, sequence, arrangement, timing, etc., of the operations or processes depicted in FIG. 11.

One or more of the techniques described herein can include timers for BSR and/or SR retransmissions. One or more timers can be implemented to improve the robustness of a BSR reporting functionality of UE 110. A BSR retransmission timer can be used to trigger UE 110 to retransmit a BSR. An SR retransmission timer can be used to trigger UE 110 to retransmit an SR. Other parameters can be used to indicate whether a BSR retransmission timer is enabled or disabled and/or whether an SR retransmission timer is enabled or disabled.

A BSR timer can be a retxBSR-Timer field, parameter, or value. An SR timer (or SR delay timer) can be a logicalChannelSR-DelayTimer field, parameter, or value. Implementation of a BSR timer and/or SR timer can help avoid a deadlock situation, such as the case where UE 110 has transmitted a BSR but does not receive a corresponding uplink grant. UE 110 can be configured to start (or restart) a BSR timer or SR timer in response to detecting or receiving an indication of a grant for transmission of new data on an uplink shared channel (UL-SCH). Upon the expiration of the timer, UE 110 can be configured to generate and communicate a regular BSR or SR to RAN 120. A logicalChannelSR-DelayTimerApplied field, parameter, or value can be used to enable or disable the use of a BSR timer or SR timer at UE 110. A BSR timer and/or SR timer can be set to false when a logicalChannelSR-DelayTimer parameter or value is not included in BSR-Config information.

As shown, UE 110-1 and UE 110-2 can have different 5G quality of service (QoS) indicators (5QIs). RAN 120 can determine and assign different BSR timer values and SR timer values to UE 110-1 and UE 110-2. The BSR timer values and SR timer values can be based on the 5QIs of UE 110-1 and UE 110-2. BSR timer values and SR timer values can be shorter for UEs 110 with greater 5QIs.

RAN 120 can communicate RRC reconfiguration information to UE 110-1 and UE 110-2. The RRC reconfiguration information can include BSR timer values and/or SR timer values assigned to UE 110-1 and UE 110-2. The BSR timer value assigned to UE 110-2 can be lower than the BSR timer value assigned to UE 110-1 as UE 110-2 has a higher scheduling priority (e.g., a 5QI 80). The higher scheduling priority can be associated with a LCH or LCG of UE 110-2. The RRC reconfiguration information can also include an indication of whether an SR timer is enabled or disabled for UE 110-1 and UE 110-2. The SR timer for UE 110-2 can be disabled, while the SR timer for UE 110-1 can be enabled.

UE 110-1 can communicate a BSR to RAN 120. UE 110-1 can initiate the BSR timer upon communicating the BSR. The BSR timer can continue until UE 110-1 receives an uplink grant. If the BSR timer expires before UE 110-1 receives an uplink grant, UE 110-1 can determine whether the SR timer (or SR delay timer) is running. If the SR timer is not running (and/or upon expiration of the SR timer) UE 110-1 can retransmit the BSR to RAN 120 and/or communicate an SR to RAN 120. While not shown, UE 110-2 can start/restart a retxBSR-Timer upon indication of a grant for transmission of new data on UL-SCH. Additionally, upon expiration of this timer, a regular or non-shallow BSR can be triggered. This timer value can be short to trigger the BSR early on rather than waiting for the retxBSR timer expiry or the SR delay timer. As such, the techniques described herein can include determining and assigning timer values based on 5QI scheduling priorities and SR/BSR optimizations and capabilities.

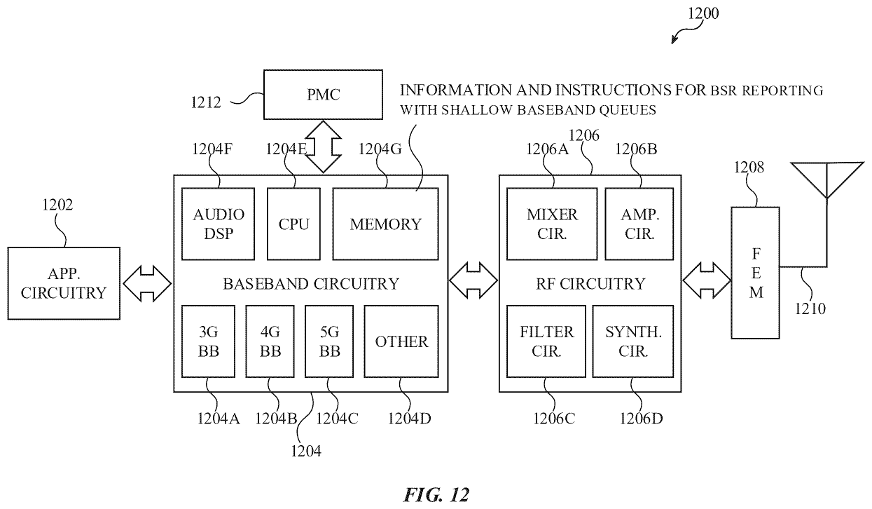

FIG. 12 is a diagram of an example of components of a device according to one or more implementations described herein. In some implementations, device 1200 can include application circuitry 1202, baseband circuitry 1204, RF circuitry 1206, front-end module (FEM) circuitry 1208, one or more antennas 1210, and power management circuitry (PMC) 1212 coupled together at least as shown. In some implementations, device 1200 can include fewer elements (e.g., a RAN node may not utilize application circuitry 1202 and can instead include a processor/controller to process data received from a core network. In some implementations, device 1200 can include additional elements such as, for example, memory/storage, display, camera, sensor (including one or more temperature sensors, such as a single temperature sensor, a plurality of temperature sensors at different locations in device 1200, etc.), or input/output (I/O) interface. In other implementations, the components described below can be included in more than one device (e.g., said circuitries can be separately included in more than one device for cloud-RAN (C-RAN) implementations).

Application circuitry 1202 can include one or more application processors. For example, application circuitry 1202 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on device 1200. In some implementations, processors of application circuitry 1202 can process data packets received from a core network.

Baseband circuitry 1204 can include circuitry such as, but not limited to, one or more single-core or multi-core processors. Baseband circuitry 1204 can include one or more baseband processors or control logic to process baseband signals received from a receive signal path of RF circuitry 1206 and to generate baseband signals for a transmit signal path of RF circuitry 1206. Baseband circuitry 1204 can interface with application circuitry 1202 for generation and processing of the baseband signals and for controlling operations of RF circuitry 1206. For example, in some implementations, baseband circuitry 1204 can include a 3G baseband processor 1204A, a 4G baseband processor 1204B, a 5G baseband processor 1204C, or other baseband processor(s) 1204D for other existing generations, generations in development or to be developed in the future (e.g., 5G, 6G, 7G, etc.). Baseband circuitry 1204 (e.g., one or more of baseband processors 1204A-D) can handle various radio control functions that enable communication with one or more radio networks via RF circuitry 1206. In other implementations, some or all of the functionality of baseband processors 1204A-D can be included in modules stored in memory 1204G and executed via a central processing unit (CPU) 1204E. The radio control functions can include, but are not limited to, signal modulation/demodulation, encoding/decoding, radio frequency shifting, etc. In some implementations, modulation/demodulation circuitry of baseband circuitry 1204 can include Fast-Fourier Transform (FFT), precoding, or constellation mapping/de-mapping functionality. In some implementations, encoding/decoding circuitry of baseband circuitry 1204 can include convolution, tail-biting convolution, turbo, Viterbi, or low-density parity check (LDPC) encoder/decoder functionality. Implementations of modulation/demodulation and encoder/decoder functionality are not limited to these examples and can include other suitable functionality in other implementations.

In some implementations, memory 1204G can receive and/or store information and instructions buffer status report (BSR) reporting. The information and instructions can be configured to cause or enable UE 110 and/or baseband circuitry 1204 to perform one or more processes or procedures, such as reporting a next higher BSR index for shallow baseband queues; estimating packet arrival times based on BSR reporting; providing a delay status report (DSR) for data in baseband queues; indicating whether logical channels (LCHs) correspond to shallow baseband queues; indicating buffer occupancy for shallow baseband queues; arbitrating between time domain resource allocations based on baseband buffer capabilities; and BSR retransmission timers and SR delay timers. These and many other features and examples are described herein.

In some implementations, baseband circuitry 1204 can include one or more audio digital signal processor(s) (DSP) 1204F. Audio DSP 1204F can include elements for compression/decompression and echo cancellation and can include other suitable processing elements in other implementations. Components of baseband circuitry 1204 can be suitably combined in a single chip, a single chipset, or disposed on a same circuit board in some implementations. In some implementations, some or all of the constituent components of baseband circuitry 1204 and application circuitry 1202 can be implemented together such as, for example, on a system on a chip (SOC).

In some implementations, baseband circuitry 1204 can provide for communication compatible with one or more radio technologies. For example, in some implementations, baseband circuitry 1204 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which baseband circuitry 1204 is configured to support radio communications of more than one wireless protocol can be referred to as multi-mode baseband circuitry.

RF circuitry 1206 can enable communication with wireless networks using modulated electromagnetic radiation through a non-solid medium. In various implementations, RF circuitry 1206 can include switches, filters, amplifiers, etc., to facilitate the communication with the wireless network. RF circuitry 1206 can include a receive signal path which can include circuitry to down-convert RF signals received from FEM circuitry 1208 and provide baseband signals to baseband circuitry 1204. RF circuitry 1206 can also include a transmit signal path which can include circuitry to up-convert baseband signals provided by baseband circuitry 1204 and provide RF output signals to FEM circuitry 1208 for transmission.

In some implementations, the receive signal path of RF circuitry 1206 can include mixer circuitry 1206A, amplifier circuitry 1206B and filter circuitry 1206C. In some implementations, the transmit signal path of RF circuitry 1206 can include filter circuitry 1206C and mixer circuitry 1206A. RF circuitry 1206 can also include synthesizer circuitry 1206D for synthesizing a frequency for use by mixer circuitry 1206A of the receive signal path and the transmit signal path. In some implementations, mixer circuitry 1206A of the receive signal path can be configured to down-convert RF signals received from FEM circuitry 1208 based on the synthesized frequency provided by synthesizer circuitry 1206D. Amplifier circuitry 1206B can be configured to amplify the down-converted signals and filter circuitry 1206C can be a low-pass filter (LPF) or band-pass filter (BPF) configured to remove unwanted signals from the down-converted signals to generate output baseband signals. Output baseband signals can be provided to baseband circuitry 1204 for further processing. In some implementations, the output baseband signals can be zero-frequency baseband signals, although this may not be a requirement. In some implementations, mixer circuitry 1206A of the receive signal path can comprise passive mixers, although the scope of the implementations is not limited in this respect.

In some implementations, mixer circuitry 1206A of the transmit signal path can be configured to up-convert input baseband signals based on the synthesized frequency provided by synthesizer circuitry 1206D to generate RF output signals for FEM circuitry 1208. The baseband signals can be provided by baseband circuitry 1204 and can be filtered by filter circuitry 1206C. In some implementations, mixer circuitry 1206A of the receive signal path and mixer circuitry 1206A of the transmit signal path can include two or more mixers and can be arranged for quadrature down conversion and up conversion, respectively. In some implementations, mixer circuitry 1206A of the receive signal path and mixer circuitry 1206A of the transmit signal path can include two or more mixers and can be arranged for image rejection. In some implementations, mixer circuitry 1206A of the receive signal path and mixer circuitry 1206A can be arranged for direct down conversion and direct up conversion, respectively. In some implementations, mixer circuitry 1206 of the receive signal path and mixer circuitry 1206A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, RF circuitry 1206 can include analog-to-digital converter (ADC) and digital-to-analog converter (DAC) circuitry and baseband circuitry 1204 can include a digital baseband interface to communicate with RF circuitry 1206.

In some dual-mode implementations, a separate radio integrated circuitry can be provided for processing signals for each spectrum, although the scope of the implementations is not limited in this respect. In some implementations, synthesizer circuitry 1206D can be a fractional-N synthesizer or a fractional N/N+1 synthesizer, although the scope of the implementations is not limited in this respect as other types of frequency synthesizers can be suitable. For example, synthesizer circuitry 1206D can be a delta-sigma synthesizer, a frequency multiplier, or a synthesizer comprising a phase-locked loop with a frequency divider.

Synthesizer circuitry 1206D can be configured to synthesize an output frequency for use by mixer circuitry 1206A of RF circuitry 1206 based on a frequency input and a divider control input. In some implementations, synthesizer circuitry 1206D can be a fractional N/N+1 synthesizer. In some implementations, frequency input can be provided by a voltage-controlled oscillator (VCO). Divider control input can be provided by either baseband circuitry 1204 or the applications circuitry 1202 depending on the desired output frequency. In some implementations, a divider control input (e.g., N) can be determined from a look-up table based on a channel indicated by the applications circuitry 1202.

Synthesizer circuitry 1206D of RF circuitry 1206 can include a divider, a delay-locked loop (DLL), a multiplexer, and a phase accumulator. In some implementations, the divider can be a dual modulus divider (DMD), and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 1206D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, RF circuitry 1206 can include an in-phase/quadrature (I/Q)/polar converter.

FEM circuitry 1208 can include a receive signal path which can include circuitry configured to operate on RF signals received from one or more antennas 1210, amplify the received signals and provide the amplified versions of the received signals to RF circuitry 1206 for further processing. FEM circuitry 1208 can also include a transmit signal path which can include circuitry configured to amplify signals for transmission provided by RF circuitry 1206 for transmission by one or more of the one or more antennas 1210. In various implementations, the amplification through the transmit or receive signal paths can be done solely in RF circuitry 1206, solely in FEM circuitry 1208, or in both RF circuitry 1206 and FEM circuitry 1208.

In some implementations, FEM circuitry 1208 can include a transmit/receive switch to switch between transmit mode and receive mode operation. FEM circuitry 1208 can include a receive signal path and a transmit signal path. The receive signal path of FEM circuitry 1208 can include a low noise amplifier to amplify received RF signals and provide the amplified received RF signals as an output (e.g., to RF circuitry 1206). The transmit signal path of FEM circuitry 1208 can include a power amplifier to amplify input RF signals (e.g., provided by RF circuitry 1206), and one or more filters to generate RF signals for subsequent transmission (e.g., by one or more of one or more antennas 1210).

In some implementations, PMC 1212 can manage power provided to baseband circuitry 1204. In particular, PMC 1212 can control power-source selection, voltage scaling, battery charging, or direct current (DC) to DC (DC-to-DC) conversion. PMC 1212 can often be included when device 1200 is capable of being powered by a battery, for example, when device 1200 is included in a UE. PMC 1212 can increase the power conversion efficiency while providing desirable implementation size and heat dissipation characteristics.

While FIG. 12 shows PMC 1212 coupled only with baseband circuitry 1204. However, in other implementations, PMC 1212 can be additionally or alternatively coupled with, and perform similar power management operations for, other components such as, but not limited to, application circuitry 1202, RF circuitry 1206, or FEM circuitry 1208.

In some implementations, PMC 1212 can control, or otherwise be part of, various power saving mechanisms of device 1200. For example, if device 1200 is in an RRC_Connected state, where device 1200 is still connected to the RAN node as device 1200 expects to receive traffic shortly, then device 1200 can enter a state known as discontinuous reception mode (DRX) after a period of inactivity. During this state, device 1200 can power down for brief intervals of time and thus save power.

If there is no data traffic activity for an extended period of time, then device 1200 can transition off to an RRC_Idle state, where device 1200 disconnects from the network and does not perform operations such as channel quality feedback, handover, etc. Device 1200 can go into a very low power state and device 1200 can perform paging where again device 1200 periodically can wake up to listen to the network and then power down again. Device 1200 may not receive data in this state; in order to receive data, device 1200 can transition back to RRC_Connected state.

An additional power saving mode can allow a device to be unavailable to the network for periods longer than a paging interval (ranging from seconds to a few hours). During this time, the device 1200 can be unreachable to the network and can power down completely. Any data sent during this time can incur a large delay and device 1200 can assume the delay is acceptable.

Processors of application circuitry 1202 and processors of baseband circuitry 1204 can be used to execute elements of one or more instances of a protocol stack. For example, processors of baseband circuitry 1204, alone or in combination, can be used execute Layer 3, Layer 2, or Layer 1 functionality, while processors of baseband circuitry 1204 can utilize data (e.g., packet data) received from these layers and further execute Layer 4 functionality (e.g., transmission communication protocol (TCP) and user datagram protocol (UDP) layers). As referred to herein, Layer 3 can comprise a radio resource control layer. As referred to herein, Layer 2 can comprise a medium access control layer, a radio link control layer, and a packet data convergence protocol layer, described in further detail below. As referred to herein, Layer 1 can comprise a physical layer of a UE/RAN node.

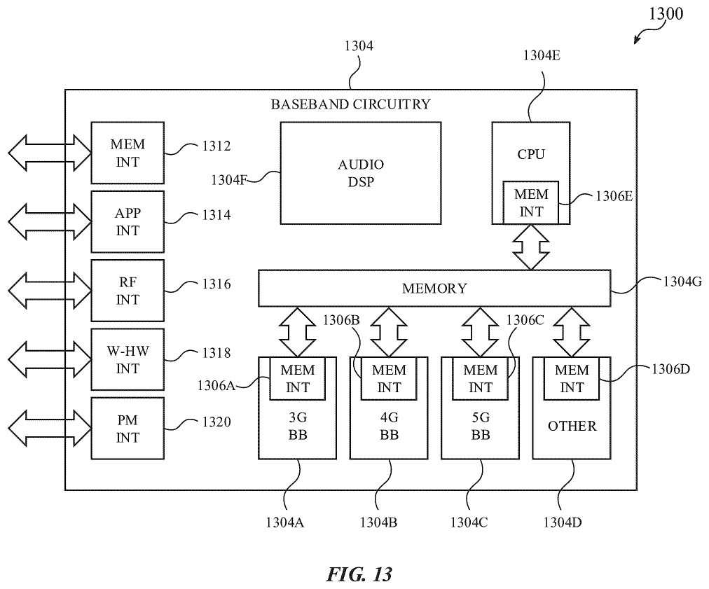

FIG. 13 is a diagram of example interfaces 1300 of baseband circuitry according to one or more implementations described herein. One or more components or features of example interfaces 1300 can correspond to one or more components or features described above or elsewhere. Baseband circuitry 1304 can comprise processors 1304A, 1304B, 1304C, 1304D, and 1304E and a memory 1304G utilized by said processors. Each of processors 1304A, 1304B, 1304C, 1304D, and 1304E can include a memory interface, 1306A, 1306B, 1306C, 1306D, and 1306E, respectively, to send/receive data to/from memory 1304G. Baseband circuitry can be a component of a UE and/or another type of device or system capable of transmitting and/or receiving wireless signals.

Baseband circuitry 1304 can further include one or more interfaces to communicatively couple to other circuitries/devices, such as memory interface 1312 (e.g., an interface to send/receive data to/from memory external to baseband circuitry 1304), an application circuitry interface 1314 (e.g., an interface to send/receive data to/from the application circuitry as described herein), an RF circuitry interface 1316, a wireless hardware connectivity interface 1318 (e.g., an interface to send/receive data to/from near field communication components, Bluetooth® components (e.g., Bluetooth® Low Energy), Wi-Fi® components, and other communication components), and a power management interface 1320 (e.g., an interface to send/receive power or control signals to/from a PMC).

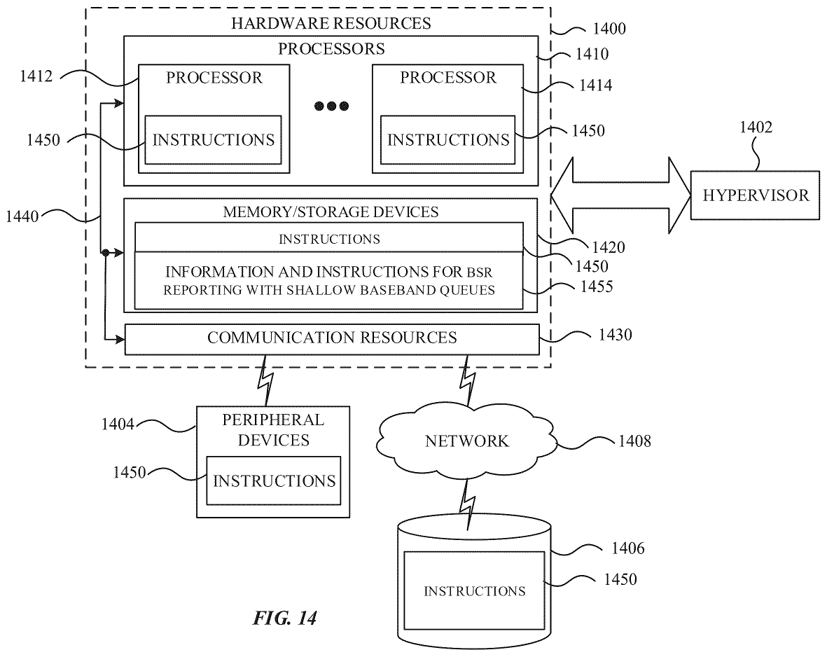

FIG. 14 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 14 shows a diagrammatic representation of hardware resources 1400 including one or more processors 1410 (or processor cores), one or more memory/storage devices 1420, and one or more communication resources 1430, each of which can be communicatively coupled via a bus 1440. For implementations where node virtualization or network function virtualization is utilized, a hypervisor can be executed to provide an execution environment for one or more network slices/sub-slices to utilize hardware resources 1400. Hardware resources 1400 can interact with hypervisor 1402. For example, hypervisor 1402 can schedule or otherwise manage hardware resource 1400.

Processors 1410 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) can include, for example, a processor 1412 and a processor 1414.

Memory/storage devices 1420 can include main memory, disk storage, or any suitable combination thereof. Memory/storage devices 1420 can include, but are not limited to any type of volatile or non-volatile memory such as dynamic random-access memory (DRAM), static random-access memory (SRAM), erasable programmable read-only memory (EPROM), electrically erasable programmable read-only memory (EEPROM), flash memory, solid-state storage, etc.

In some implementations, memory/storage devices 1420 receive and/or store information and instructions 1455 for buffer status report (BSR) reporting. The information and instructions can be configured to cause or enable UE 110 to perform one or more processes or procedures, such as reporting a next higher BSR index for shallow baseband queues; estimating packet arrival times based on BSR reporting; providing a delay status report (DSR) for data in baseband queues; indicating whether logical channels (LCHs) correspond to shallow baseband queues; indicating buffer occupancy for shallow baseband queues; arbitrating between time domain resource allocations based on baseband buffer capabilities; and BSR retransmission timers and SR delay timers. These and many other features and examples are described herein.

Communication resources 1430 can include interconnection or network interface components or other suitable devices to communicate with one or more peripheral devices 1404 or one or more databases 1406 via a network 1408. For example, communication resources 1430 can include wired communication components (e.g., for coupling via a universal serial bus), cellular communication components, near field communication components, Bluetooth® components (e.g., Bluetooth® Low Energy), Wi-Fi® components, and other communication components.

Instructions 1450A, 1450B, 1450C, 1450D, and/or 1450E can comprise software, a program, an application, an applet, an app, or other executable code for causing at least any of processors 1410 to perform any one or more of the methodologies discussed herein. Instructions 1450 can reside, completely or partially, within at least one of processors 1410 (e.g., within a cache memory), memory/storage devices 1420, or any suitable combination thereof. Furthermore, any portion of instructions 1450A-E can be transferred to hardware resources 1400 from any combination of peripheral devices 1404 or databases 1406. Accordingly, memory of processors 1410, memory/storage devices 1420, peripheral devices 1404, and databases 1406 are examples of computer-readable and machine-readable media.

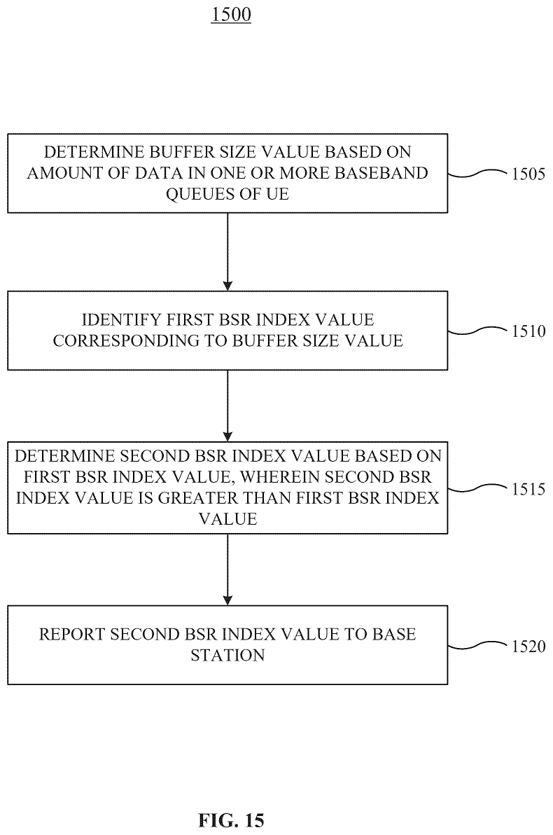

FIG. 15 is a block diagram of an example logic flow 1500 according to one or more implementations described herein. Logic flow 1500 may be representative, for instance, of operations that may be performed by UE 110 in FIG. 2. According to logic flow 1500, a buffer size value may be determined at 1505 based on an amount of data in one or more baseband queues of a UE. At 1510, a first BSR index value may be identified that corresponds to the buffer size value determined at 1505. In some embodiments, the first BSR index value may be identified based on a defined mapping of the first BSR index value to a buffer size value range that includes the buffer size value. At 1515, a second BSR index value may be determined based on the first BSR index value, and the second BSR index value may be greater than the first BSR index value. In some embodiments, the first BSR index value may be identified from among a plurality of defined BSR index values based on the buffer size value. In some embodiments, relative to the first BSR index value, the second BSR index value may comprise a next higher BSR index value among the plurality of defined BSR index values. In some embodiments, the second BSR index value may be determined by incrementing the first BSR index value. At 1520, the second BSR index value may be reported to a base station. In some embodiments, the second BSR index value may be reported to the base station by sending, to the base station, a buffer status report comprising the second BSR index value. In some embodiments, downlink control information (DCI) may be received from the base station in response to the reporting of the second BSR index value to the base station, the DCI may comprise a UL grant for the UE, and a padding BSR may be sent to the base station using UL resources associated with the UL grant.

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

Example 1 is a user equipment (UE), comprising a memory configured to store one or more instructions and one or more processors configured to, when executing the one or more instructions, cause the UE to determine a buffer size value based on an amount of data in one or more baseband queues of the UE, identify a first buffer status report (BSR) index value corresponding to the buffer size value, determine a second BSR index value based on the first BSR index value, wherein the second BSR index value is greater than the first BSR index value, and report the second BSR index value to a base station.

Example 2 is the UE of example 1, the one or more processors configured to, when executing the one or more instructions, cause the UE to report the second BSR index value to the base station by sending, to the base station, a buffer status report comprising the second BSR index value.

Example 3 is the UE of example 1, the one or more processors configured to, when executing the one or more instructions, cause the UE to identify the first BSR index value based on a defined mapping of the first BSR index value to a buffer size value range that includes the buffer size value.

Example 4 is the UE of example 1, the one or more processors configured to, when executing the one or more instructions, cause the UE to identify the first BSR index value from among a plurality of defined BSR index values based on the buffer size value.

Example 5 is the UE of example 4, wherein relative to the first BSR index value, the second BSR index value comprises a next higher BSR index value among the plurality of defined BSR index values.

Example 6 is the UE of example 1, the one or more processors configured to, when executing the one or more instructions, cause the UE to determine the second BSR index value by incrementing the first BSR index value.

Example 7 is the UE of example 1, the one or more processors configured to, when executing the one or more instructions, cause the UE to receive, from the base station, in response to reporting the second BSR index value to the base station, downlink control information (DCI) comprising an uplink (UL) grant for the UE, and send a padding BSR to the base station using UL resources associated with the UL grant.

Example 8 is a method for wireless communication by a user equipment (UE), comprising determining a buffer size value based on an amount of data in one or more baseband queues of the UE, identifying a first buffer status report (BSR) index value corresponding to the buffer size value, determining a second BSR index value based on the first BSR index value, wherein the second BSR index value is greater than the first BSR index value, and reporting the second BSR index value to a base station.

Example 9 is the method of example 8, comprising reporting the second BSR index value to the base station by sending, to the base station, a buffer status report comprising the second BSR index value.

Example 10 is the method of example 8, comprising identifying the first BSR index value based on a defined mapping of the first BSR index value to a buffer size value range that includes the buffer size value.

Example 11 is the method of example 8, comprising identifying the first BSR index value from among a plurality of defined BSR index values based on the buffer size value.

Example 12 is the method of example 11, wherein relative to the first BSR index value, the second BSR index value comprises a next higher BSR index value among the plurality of defined BSR index values.

Example 13 is the method of example 8, comprising determining the second BSR index value by incrementing the first BSR index value.

Example 14 is the method of example 8, comprising receiving, from the base station, in response to reporting the second BSR index value to the base station, downlink control information (DCI) comprising an uplink (UL) grant for the UE, and sending a padding BSR to the base station using UL resources associated with the UL grant.

Example 15 is a non-transitory computer-readable storage medium, comprising instructions that, when executed by one or more processors of a user equipment (UE), cause the UE to determine a buffer size value based on an amount of data in one or more baseband queues of the UE, identify a first buffer status report (BSR) index value corresponding to the buffer size value, determine a second BSR index value based on the first BSR index value, wherein the second BSR index value is greater than the first BSR index value, and report the second BSR index value to a base station.

Example 16 is the non-transitory computer-readable storage medium of example 15, comprising instructions that, when executed by one or more processors of the UE, cause the UE to report the second BSR index value to the base station by sending, to the base station, a buffer status report comprising the second BSR index value.

Example 17 is the non-transitory computer-readable storage medium of example 15, comprising instructions that, when executed by one or more processors of the UE, cause the UE to identify the first BSR index value based on a defined mapping of the first BSR index value to a buffer size value range that includes the buffer size value.

Example 18 is the non-transitory computer-readable storage medium of example 15, comprising instructions that, when executed by one or more processors of the UE, cause the UE to identify the first BSR index value from among a plurality of defined BSR index values based on the buffer size value.

Example 19 is the non-transitory computer-readable storage medium of example 18, wherein relative to the first BSR index value, the second BSR index value comprises a next higher BSR index value among the plurality of defined BSR index values.

Example 20 is the non-transitory computer-readable storage medium of example 15, comprising instructions that, when executed by one or more processors of the UE, cause the UE to determine the second BSR index value by incrementing the first BSR index value.

Example 21 is the non-transitory computer-readable storage medium of example 15, comprising instructions that, when executed by one or more processors of the UE, cause the UE to receive, from the base station, in response to reporting the second BSR index value to the base station, downlink control information (DCI) comprising an uplink (UL) grant for the UE, and send a padding BSR to the base station using UL resources associated with the UL grant.

Example 22 is an apparatus, comprising means for determining a buffer size value based on an amount of data in one or more baseband queues of a user equipment (UE), means for identifying a first buffer status report (BSR) index value corresponding to the buffer size value, means for determining a second BSR index value based on the first BSR index value, wherein the second BSR index value is greater than the first BSR index value, and means for reporting the second BSR index value to a base station.

Example 23 is the apparatus of example 22, comprising means for reporting the second BSR index value to the base station by sending, to the base station, a buffer status report comprising the second BSR index value.

Example 24 is the apparatus of example 22, comprising means for identifying the first BSR index value based on a defined mapping of the first BSR index value to a buffer size value range that includes the buffer size value.

Example 25 is the apparatus of example 22, comprising means for identifying the first BSR index value from among a plurality of defined BSR index values based on the buffer size value.

Example 26 is the apparatus of example 25, wherein relative to the first BSR index value, the second BSR index value comprises a next higher BSR index value among the plurality of defined BSR index values.

Example 27 is the apparatus of example 22, comprising means for determining the second BSR index value by incrementing the first BSR index value.

Example 28 is the apparatus of example 22, comprising means for receiving, from the base station, in response to reporting the second BSR index value to the base station, downlink control information (DCI) comprising an uplink (UL) grant for the UE, and means for sending a padding BSR to the base station using UL resources associated with the UL grant.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature can have been disclosed with respect to only one of several implementations, such feature can be combined with one or more other features of the other implementations as can be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context can indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

What is claimed is:

1. A user equipment (UE), comprising:
a memory configured to store one or more instructions; and
one or more processors configured to, when executing the one or more instructions, cause the UE to:
determine a buffer size value based on an amount of data in one or more baseband queues of the UE;
identify a first buffer status report (BSR) index value corresponding to the buffer size value;
determine a second BSR index value based on the first BSR index value, wherein the second BSR index value is greater than the first BSR index value; and
report the second BSR index value to a base station.

2. The UE of claim 1, the one or more processors configured to, when executing the one or more instructions, cause the UE to report the second BSR index value to the base station by sending, to the base station, a buffer status report comprising the second BSR index value.

3. The UE of claim 1, the one or more processors configured to, when executing the one or more instructions, cause the UE to identify the first BSR index value based on a defined mapping of the first BSR index value to a buffer size value range that includes the buffer size value.

4. The UE of claim 1, the one or more processors configured to, when executing the one or more instructions, cause the UE to identify the first BSR index value from among a plurality of defined BSR index values based on the buffer size value.

5. The UE of claim 4, wherein relative to the first BSR index value, the second BSR index value comprises a next higher BSR index value among the plurality of defined BSR index values.

6. The UE of claim 1, the one or more processors configured to, when executing the one or more instructions, cause the UE to determine the second BSR index value by incrementing the first BSR index value.

7. The UE of claim 1, the one or more processors configured to, when executing the one or more instructions, cause the UE to:
receive, from the base station, in response to reporting the second BSR index value to the base station, downlink control information (DCI) comprising an uplink (UL) grant for the UE; and
send a padding BSR to the base station using UL resources associated with the UL grant.

8. A method for wireless communication by a user equipment (UE), comprising:
determining a buffer size value based on an amount of data in one or more baseband queues of the UE;
identifying a first buffer status report (BSR) index value corresponding to the buffer size value;
determining a second BSR index value based on the first BSR index value, wherein the second BSR index value is greater than the first BSR index value; and
reporting the second BSR index value to a base station.

9. The method of claim 8, comprising reporting the second BSR index value to the base station by sending, to the base station, a buffer status report comprising the second BSR index value.

10. The method of claim 8, comprising identifying the first BSR index value based on a defined mapping of the first BSR index value to a buffer size value range that includes the buffer size value.

11. The method of claim 8, comprising identifying the first BSR index value from among a plurality of defined BSR index values based on the buffer size value.

12. The method of claim 11, wherein relative to the first BSR index value, the second BSR index value comprises a next higher BSR index value among the plurality of defined BSR index values.

13. The method of claim 8, comprising determining the second BSR index value by incrementing the first BSR index value.

14. The method of claim 8, comprising:
receiving, from the base station, in response to reporting the second BSR index value to the base station, downlink control information (DCI) comprising an uplink (UL) grant for the UE; and
sending a padding BSR to the base station using UL resources associated with the UL grant.

15. A non-transitory computer-readable storage medium, comprising instructions that, when executed by one or more processors of a user equipment (UE), cause the UE to:
determine a buffer size value based on an amount of data in one or more baseband queues of the UE;
identify a first buffer status report (BSR) index value corresponding to the buffer size value;
determine a second BSR index value based on the first BSR index value, wherein the second BSR index value is greater than the first BSR index value; and
report the second BSR index value to a base station.

16. The non-transitory computer-readable storage medium of claim 15, comprising instructions that, when executed by one or more processors of the UE, cause the UE to report the second BSR index value to the base station by sending, to the base station, a buffer status report comprising the second BSR index value.

17. The non-transitory computer-readable storage medium of claim 15, comprising instructions that, when executed by one or more processors of the UE, cause the UE to identify the first BSR index value based on a defined mapping of the first BSR index value to a buffer size value range that includes the buffer size value.

18. The non-transitory computer-readable storage medium of claim 15, comprising instructions that, when executed by one or more processors of the UE, cause the UE to identify the first BSR index value from among a plurality of defined BSR index values based on the buffer size value.

19. The non-transitory computer-readable storage medium of claim 18, wherein relative to the first BSR index value, the second BSR index value comprises a next higher BSR index value among the plurality of defined BSR index values.

20. The non-transitory computer-readable storage medium of claim 15, comprising instructions that, when executed by one or more processors of the UE, cause the UE to determine the second BSR index value by incrementing the first BSR index value.
